(19) United States
(12) Patent Application Publication
(10) Pub. No.: US 2026/0169248 A1
(43) Pub. Date: Jun. 18, 2026

(54) COMMUNICATIONS PANEL SYSTEMS

(71) Applicant: CommScope Technologies LLC, Claremont, NC (US)

(72) Inventors: David Jan Irma VAN BAELEN, Winksele (BE); Rodney C. SCHOENFELDER, Shakopee, MN (US); Jacob C. ANDERSON, Chanhassen, MN (US); Peter James SIKOROWSKI, Waconia, MN (US); Michael J. SCHOMISCH, Rosemount, MN (US)

(73) Assignee: CommScope Technologies LLC, Claremont, NC (US)

(21) Appl. No.: 19/124,112

(22) PCT Filed: Oct. 31, 2023
(86) PCT No.: PCT/US2023/036508

§ 371 Date: Apr. 24, 2025

Related U.S. Application Data
(60) Provisional application No. 63/381,658, filed on Oct. 31, 2022.
(60) Provisional application No. 63/497,005, filed on Apr. 19, 2023.

(51) Int. Cl. G02B 6/44; H01R 13/514

(52) U.S. Cl. CPC G02B 6/4455; G02B 6/4452; H01R 13/514

(57) ABSTRACT

A communications panel includes one or more trays mounted within a chassis. The chassis includes opposing side members that hold the trays in fixed positions relative to the chassis. The side members also define cable routing rings at a front of the chassis. Each tray holds one or more cassette guides along which cassettes can be slidingly mounted to the trays. The side members may include mounting guides to assist in guiding the cassettes onto the cassette guides to mount the cassettes to the trays.

### CROSS-REFERENCE TO RELATED APPLICATIONS

This application is being filed on Oct. 31, 2023, as a PCT International Application and claims the benefit of U.S. Provisional Application No. 63/381,658, filed Oct. 31, 2022, and U.S. Provisional Application No. 63/497,005, filed Apr. 19, 2023, the disclosures of which are hereby incorporated by reference in their entireties.

### BACKGROUND

In the telecommunications industry, the demand for added capacity is growing rapidly. This demand is being met in part by the increasing use and density of fiber optic transmission equipment. Even though fiber optic equipment permits higher levels of transmission in the same or smaller footprint than traditional copper transmission equipment, the demand requires even higher levels of fiber density. This has led to the development of high-density fiber handling equipment.

In communications panel systems, port members (e.g., optical adapters, electrical jacks, hybrid port members, etc.) defining front ports are mounted to one or more trays that are disposable within a chassis. The front ports are configured to receive plug connectors at the fronts of the trays. The trays can either be stationary within a chassis or can slide forwardly of the chassis to enhance access to the port members.

Improvements are desired.

### SUMMARY

A communications panel includes a chassis holding one or more trays. Each tray spans a width and depth of the chassis. In certain implementations, the trays are stationary within the chassis. Each tray is configured to support one or more cassettes carrying ports (e.g., optical ports, electrical ports, or hybrid ports) to receive plug connectors. The cassettes are slidably mounted to the tray along cassette guides. Each tray populated with one or more cassettes is referred to herein as a communications arrangement.

In accordance with certain aspects of the disclosure, the trays are mounted within the chassis at axially fixed locations using side members. A pair of side members is coupled to one or more trays to form a tray arrangement that can be mounted to a chassis. In certain implementations, each side member includes a tray retention section that holds one or more trays.

In certain implementations, the side members define retaining rings at a front of the side member to guide media segments (e.g., fiber cables, electrical cables, hybrid cables, etc.) across the front of the chassis.

In certain implementations, the side members define indicator regions at which labels can be mounted. In certain examples, the tray retention section is disposed between the retaining rings and the indicator regions.

In some implementations, the tray retention sections define multiple recesses to receive multiple trays. In other implementations, the tray retention sections each define a single recess at which to receive multiple trays.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a front perspective view of a first example communications panel configured in accordance with the principles of the present disclosure;

FIG. 2 is a perspective view of an example tray arrangement suitable for use in the first communications panel of FIG. 1, the components of the tray arrangement being exploded from each other for ease in viewing;

FIG. 3 is a top plan view of an example tray base suitable for use in the tray arrangement of FIG. 2;

FIG. 4 is a perspective view of an example side member suitable for use in the tray arrangement of FIG. 2;

FIG. 5 is a perspective view of the communications panel of FIG. 1 with the top piece removed for ease in viewing the tray arrangements;

FIG. 6 is a front elevational view of the communications panel of FIG. 1;

FIG. 7 is an enlarged view of a portion of FIG. 6;

FIG. 8 is a rear perspective view of the communications panel of FIG. 1;

FIG. 9 is an exploded view of the communications panel of FIG. 1;

FIG. 10 is an exploded view of a second example communications panel configured in accordance with the principles of the present disclosure;

FIG. 11 is a perspective view of a second example side member suitable for use in the communications panels of FIGS. 10 and 14;

FIG. 12 is a side elevational view of the side member of FIG. 11;

FIG. 13 is a perspective view of the side member of FIG. 11;

FIG. 14 is a perspective view of a third example communications panel configured in accordance with the principles of the present disclosure;

FIG. 15 is an exploded view of the communications panel of FIG. 14;

FIG. 16 shows a packaging stabilizer aligned with the trays of the communications panel of FIG. 14;

FIG. 17 is a perspective view of the packaging stabilizer of FIG. 16;

FIG. 18 is a top perspective view of the packaging stabilizer of FIG. 16;

FIG. 19 is a perspective view of a fourth example communications panel configured in accordance with the principles of the present disclosure, the fourth communications panel having a top piece exploded upwardly for ease in viewing the tray arrangement;

FIG. 20 is a perspective view of the communications panel of FIG. 19 showing the top piece removed and the tray bases exploded outwardly from the chassis for ease in viewing the side members;

FIG. 21 shows the communications panel of FIG. 20 with the side member of one side of the chassis exploded upwardly and only one of the tray bases visible;

FIG. 22 is a top perspective view of an example tray base suitable for use in the tray arrangement of the communications panel of FIG. 20;

FIG. 23 is a bottom perspective view of the tray base of FIG. 22;

FIG. 24 is a front elevational view of the tray base of FIG. 22;

FIG. 25 is a perspective view of the third example side member suitable for use with the tray arrangement of the fourth communications panel of FIG. 19;

FIG. 26 is a perspective view of the second example communications panel of FIG. 10 with an alternative implementation of the cable management region; and

FIG. 27 illustrates how cables can be routed and secured at the cable management region of FIG. 26.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

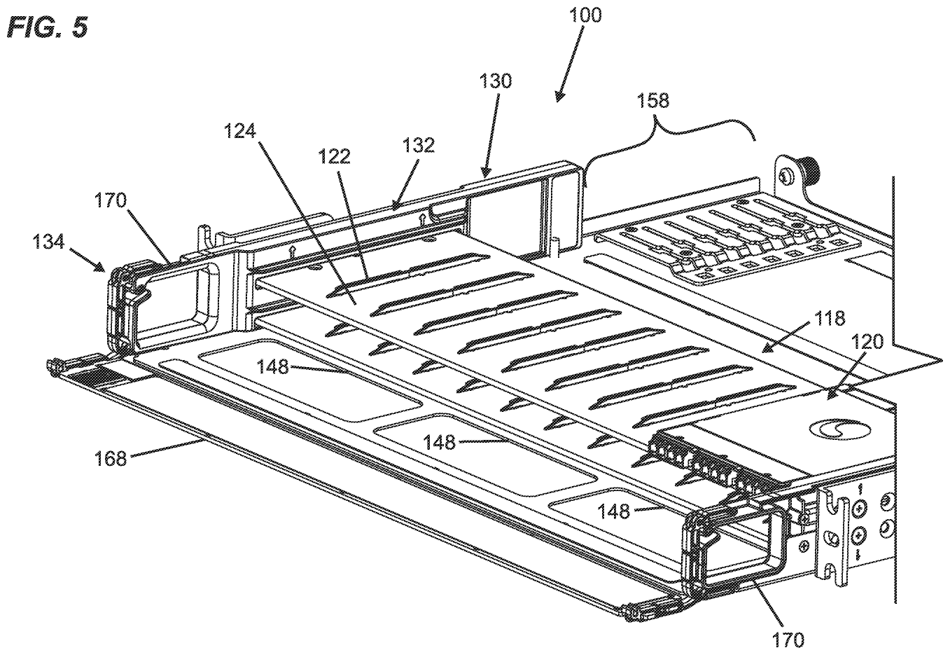

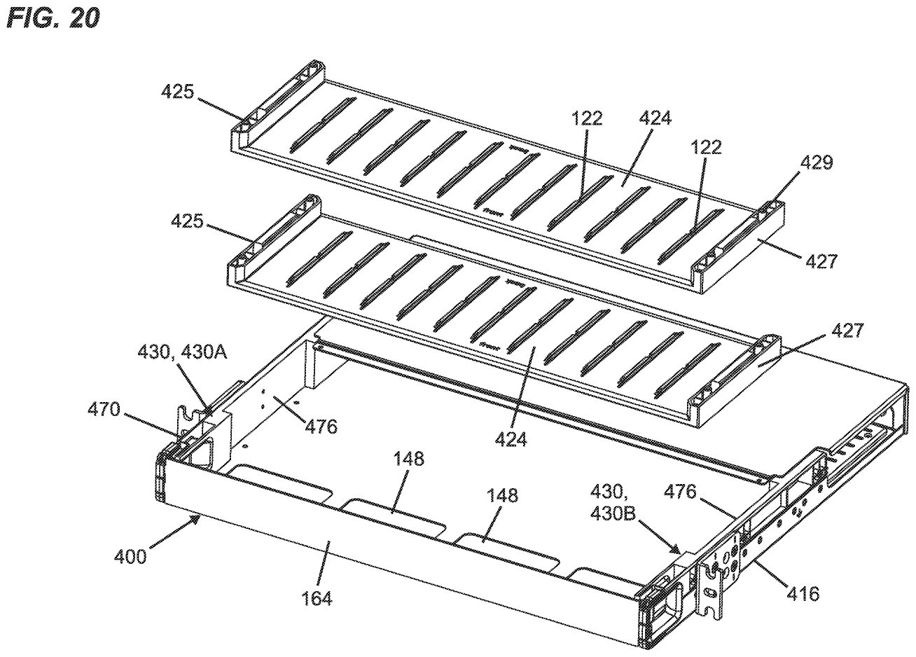

The present disclosure is directed to a communications panel 100, 200, 300, 400 configured to mount to a rack (e.g., via mounting brackets B). The communications panel 100, 200, 300, 400 includes a chassis 116, 216, 316, 416 holding one or more tray arrangements 118, 218, 318, 418 (e.g., see FIGS. 5, 10, 15, and 20). The chassis 116, 216, 316, 416 extends along a depth D between a front 102 and a rear 104, along a width W between a first side 106 and a second side 108, and along a height H between a top 110 and a bottom. Each tray arrangement 118, 218, 318, 418 spans the width W of the chassis 116, 216, 316, 416. The tray arrangements 118, 218, 318, 418 are axially fixed along the depth D of the chassis 116, 216, 316, 416.

Each tray arrangement 118, 218, 318, 418 is configured to support one or more cassettes 120. In some implementations, an example cassette 120 carries one or more ports (e.g., optical ports, electrical ports, hybrid ports, etc.) configured to receive plug connectors. In other implementations, an example cassette 120 carries other communication components such as a splice component (e.g., splice tray, splice chip, or other protection arrangement), an optical splitter (e.g., a power splitter, a wave division multiplexer, an optical tap, etc.), and/or media segment storage arrangements (e.g., spools, bend radius limiters, guides, etc.).

An example tray arrangement 118, 218, 318, 418 includes a tray base 124 extending between a first side member 130, 130A, 230, 230A, 430, 430A, and a second side member 130, 130B, 230, 230B, 430, 430B. The first side member 130, 130A, 230, 230A, 430, 430A is mounted to the first side 106 of the chassis 116, 216, 316, 416 and the second side member 130, 130B, 230, 230B, 430, 430B is mounted to the second side 108 of the chassis 116, 216, 316, 416. The side members 130, 230, 430 hold the tray base 124 at a fixed position relative to the chassis 116, 216, 316, 416. For example, the side members 130, 230, 430 inhibit axial movement of the tray base 124 along the depth D of the chassis 116, 216, 316, 416.

Each side member 130, 230, 430 has a fiber guide section 134, 234, 434 disposed at the front 106 of the chassis 116, 216, 316, 416 and a tray retention section 132, 432 disposed rearwardly of the fiber guide section 134, 434. In certain implementations, each side member 130, 230, 430 is elongate along the depth D of the chassis 116, 216, 316, 416. The tray base 124 is elongate along the width W of the chassis 116, 216, 316, 416 between opposite first and second ends 125, 127. The first end 125 of the tray base 124 is retained at the tray retention section 132, 432 of the first side member 130, 130A, 230, 230A, 430, 430A. The second end 127 of the tray base 124 is retained at the tray retention section 132, 432 of the second side member 130, 130B, 230, 230B, 430, 430B.

In certain implementations, the fiber guide section 134, 234, 434 includes a retaining ring 170, 470 disposed at the front of the side member 130, 230, 430. The retaining ring 170, 470 extends along the height H of the chassis 116, 216, 316, 416 and along the depth D of the chassis 116, 216, 316, 416 to define a passage 172, 472 extending along the width W of the chassis 116, 216, 316, 416. In certain implementations, the retaining ring 170, 470 defines an entrance 174, 474 through which media segments (e.g., fiber cables, electrical cable, hybrid cables, etc.) can enter the passage 172, 472. In certain examples, the entrance 174, 474 is disposed at a front of the retaining ring 170, 470. In some examples, the entrance 174 is disposed towards a top of the front of the retaining ring 170. In other examples, the entrance 474 is disposed towards a center of the front of the retaining ring 470. In certain examples, the entrance 174 extends at an angle to the depth D of the chassis 116, 216, 316, 416 between the exterior of the retaining ring 170 and the passage 172. In the example shown, the entrance 174 angles upwardly as the entrance 174 extends from an exterior of the ring 170 towards the passage 172.

The tray base 124 includes a plurality of cassettes guides 122 extending along the depth D of the chassis 116, 216, 316, 416. The cassette guides 122 are spaced from each other along the width W of the chassis 116, 216, 316, 416. The guides 122 are configured to slidingly receive a plurality of cassettes 120 along the guides 122 from either the front end 126 of the base 124 or from the rear end 128 of the base 124 at a discretion of a user. In certain implementations, the cassette guides 122 have an L-shape. Each cassette 120 includes a latching arrangement that releasably locks the cassette in a fixed position relative to the tray arrangement 118, 218, 318, 418. Examples of suitable latching arrangements and corresponding structure on the guides 122 is disclosed in WO 2022/178310, the disclosure of which is hereby incorporated herein by reference in its entirety.

As will be discussed in more detail herein, a cassette 120 carries one or more front ports at a front of the cassette 120. The front ports are configured to receive plug connectors. In some implementations, the front ports are optical ports configured to receive optical plug connectors. In other implementations, the front ports may be electrical ports configured to receive electrical plug connectors, hybrid ports configured to receive hybrid plug connectors, or a mixture thereof. In some implementations, a cassette 120 carries single-fiber front ports (e.g., LC front ports). In other implementations, a cassette 120 carries multi-fiber front ports (e.g., MPO front ports, SN front ports offered by Senko, etc.). In still other implementations, the same cassette 120 may carry a mix of two or more types of front ports (e.g., a mixture of MPO and LC ports).

In some implementations, the cassette 120 carries one or more rear ports (e.g., optical port, electrical port, hybrid port, etc.) at the rear of the cassette 120. Each rear port is configured to receive a plug connector. Intermediate optical fibers within the cassette connect the front and rear ports. In other implementations, the cassette 120 carries ports only at the front of the cassette 120. In such implementations, a rear of the cassette 120 is configured to enable optical fibers or one or more optical fiber cables to extend into/onto the cassette 120 and be routed towards the front ports.

The guides 122 and the cassettes 120 are configured so the sizes of the cassettes 120 need not be in integer increments of each other to each fit on the same tray arrangement 118, 218, 318, 418 with the same configuration of guides 122. For example, the tray arrangement 118, 218, 318, 418 may receive a first cassette 120 having a first width and a second cassette having a second width that is 1.5 times the first width. Accordingly, the same tray can be fully populated by a plurality of cassettes having the first width or by a plurality of cassettes having the second width at the discretion of the user without modifying the guides or the tray. In other cases, cassettes of different widths can be mixed on the tray.

In various implementations, a cassette 120 can be a base-8 cassette, a base-12 cassette, or another type of cassette (e.g., a base-2 cassette, a base-16 cassette, a base-24 cassette, etc.). A base-8 cassette receives fibers at the rear (e.g., through a rear adapter or through fibers extending into the cassette) in increments of eight whereas a base-12 cassette receives fiber at the rear in increments of twelve. In certain examples, a base-16 cassette receives fibers at the rear in increments of sixteen and a base-24 cassette receives fibers at the rear in increments of twenty-four. In certain implementations, a base-8 cassette receives plug connectors having eight live fibers at a rear of the cassette 120, a base-12 cassette receives plug connectors having twelve live fibers at a rear of the cassette 120, a base-16 cassette receives plug connectors having sixteen live fibers at a rear of the cassette 120, and a base-24 cassette receives plug connectors having twenty-four live fibers at a rear of the cassette 120.

In certain implementations, a base-12 cassette has a larger width than a base-8 cassette. For example, a base-12 cassette providing a row of six duplex-LC front ports (i.e., twelve LC front ports) may be wider than a base-8 cassette providing a row of four duplex-LC front ports (i.e., eight LC front ports). In an example, such a base-12 cassette may be 1.5 times as wide as the base-8 cassette. In such implementations, the tray arrangement 118, 218, 318, 418 could be populated with the base-8 cassettes, the base-12 cassettes, or a combination thereof without modification to the arrangement of the guides 122. In other implementations, however, a base-8 cassette and a base-12 cassette can have the same width depending on port type.

In accordance with aspects of the disclosure, the chassis 116, 216, 316, 416 includes a bottom piece 140 and a top piece 142. The bottom piece 140 defines the bottom of the chassis 116, 216, 316, 416. The top piece 142 defines the top 110 of the chassis 116, 216, 316, 416. The top and bottom pieces 140, 142 cooperate to define a first sidewall 144 and a second sidewall 146 of the chassis 116, 216, 316, 416 at the first and second sides 106, 108. The first side member 130, 130A, 230, 230A, 430 is mounted to the first sidewall 144 and the second side member 130, 130A, 230, 230A, 430 is mounted to the second sidewall 146.

The bottom piece 140 includes a base 150, 250, 350, 450 extending along the width W and depth D of the chassis 116, 216, 316, 416. In certain implementations, the bottom piece 140 also includes side flanges 152, 252, 352, 452 extending upwardly from the base 150, 250, 350, 450 at opposite sides 106, 108 of the base 150, 250, 350, 450. The top piece 142 includes a cover 154, 354, 454 extending along the width W and depth D of the chassis 116, 216, 316, 416. In certain implementations, the top piece 142 also includes side flanges 156, 356, 456 extending downwardly from the cover 154, 354, 454 at opposite sides 106, 108 of the cover 154, 254, 354, 454. In certain implementations, each side member 130, 130A, 230, 230A, 430 is mounted (e.g., via fasteners, latches, etc.) to both the flanges 152, 252, 352, 452 of the bottom piece 140 and the flanges 156, 356, 456 of the top piece 142.

In certain implementations, the base 150, 250, 350, 450 of the bottom piece 140 defines an access aperture 148 at the bottom of the chassis 116, 216, 316, 416. The access aperture 148 is located towards the front 102 of the chassis 116, 216, 316, 416 to provide finger access to front ports of cassettes 120 mounted to the tray arrangements 118, 218, 318, 418. In certain examples, the access aperture 148 spans at least a gap G (FIG. 3) between two adjacent ones of the cassette guides 122. In certain implementations, the access aperture 148 spans multiple cassette guides 122 and gaps G. In certain implementations, the access aperture 148 is one of a plurality of access apertures. In certain examples, the access apertures 148 are disposed in a row across a majority of the width W of the chassis 116, 216, 316, 416. In the example shown, the base 150, 250, 350, 450 defines three access apertures 148. In other examples, however, the base 150, 250, 350, 450 can be define a greater (e.g., four) or lesser (e.g., two) number of access apertures 148.

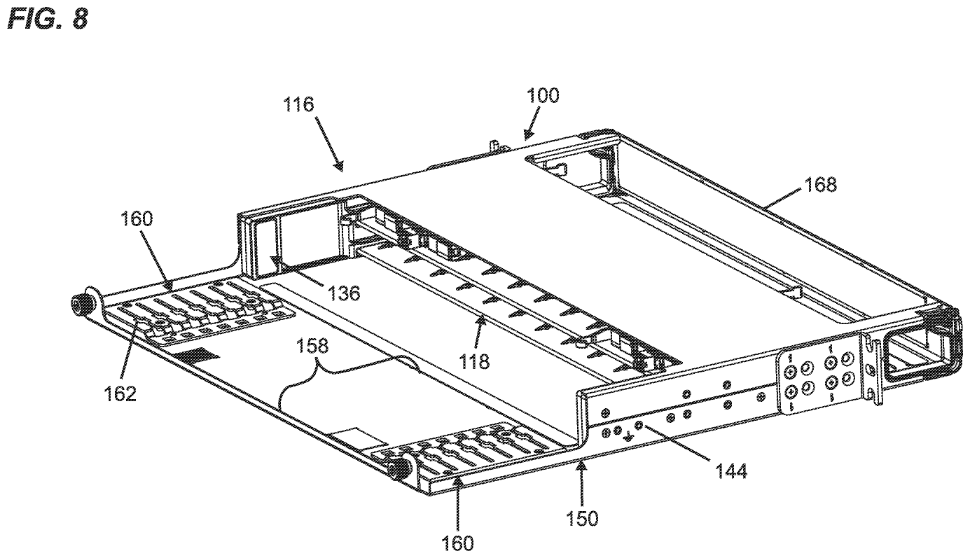

In certain implementations, a cable management region 158 is disposed rearward of the tray arrangement 118, 218, 318, 418. In certain examples, the cable management region 158 is defined by a rearward portion of the base 150, 250, 350, 450. For example, the base 150, 250, 350, 450 may extend rearwardly beyond the top piece 142 to define the cable management region 158. One or more cable anchor stations 160 are disposed at the cable management region 158. In some implementations, anchor plates 162 may be disposed at the anchor stations 160 (e.g., see FIGS. 5 and 8). One or more cable anchors can be mounted to the anchor plates 162. Example anchor plates suitable for use at a cable anchor station 160 are disclosed in PCT Application No. PCT/US2022/025731, filed Apr. 21, 2022, and titled “Cable Anchor System,” the disclosure of which is hereby incorporated herein by reference in its entirety.

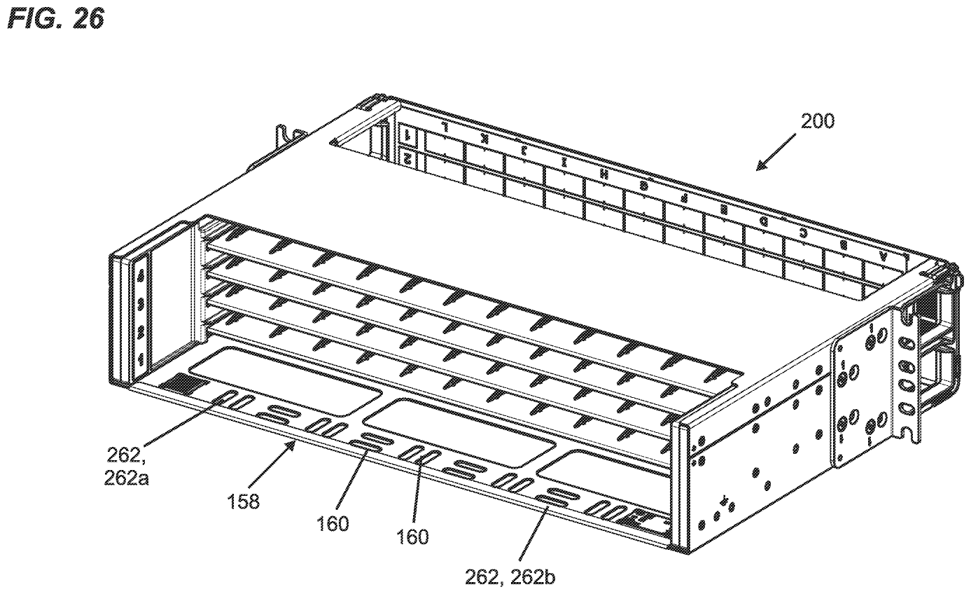

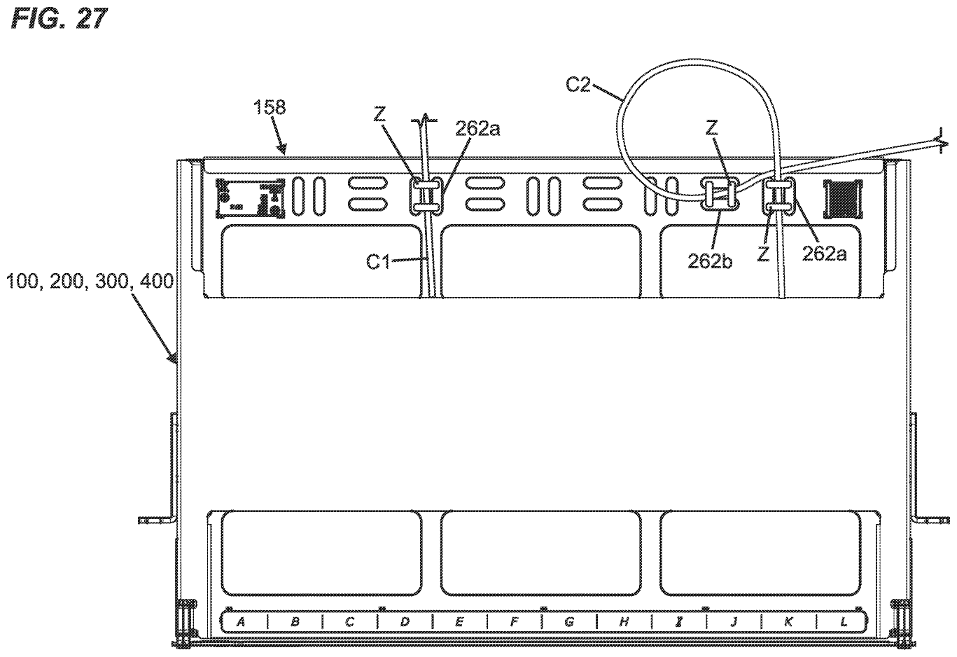

In other implementations, the cable anchor stations 160 define slot pairs 262 at which a cable tie Z or other wrap-style fastener can be secured (e.g., see FIGS. 26 and 27). In certain implementations, the slot pairs 262 are arranged in different orientations. For example, some of the slot pairs 262a are oriented to extend along the depth D of the chassis 116, 216, 316, 416 while others of the slot pairs 262b are oriented to extend along the width W of the chassis 116, 216, 316, 416. In certain examples, the slot pairs 262a, 262b are alternate along a row. In FIG. 27, a first cable C1 is shown routed straight out of the chassis 116, 216, 316, 416 and secured by cable ties Z at a cable anchor slot pair 262a. A second cable C2 is shown secured to a cable anchor slot pair 262a, looped around, and secured to a cable anchor slot pair 262b to adjust the direction in which the second cable C2 extends from the chassis 116, 216, 316, 416.

In certain implementations, a front door 164 is disposed at the front 102 of the chassis 116, 216, 316, 416. In certain examples, the front door 164 is configured to selectively cover an open front of the chassis 116, 216, 316, 416. In certain examples, the front door 164 is configured to selective block access to the front ports carried by the cassettes 120 mounted to the tray arrangement 118, 218, 318, 418. In certain examples, the front door 164 is configured to move between a closed position extending across the front 102 of the chassis 116, 216, 316, 416 and an open position providing access to the front 102 of the chassis 116, 216, 316, 416. In an example, the front door 164 pivots between the open and closed positions. In another example, the front door 164 is moved between the open and closed positions via a living hinge. Example front doors suitable for use with the chassis 116, 216, 316, 416 of the present disclosure are disclosed in PCT Publication No. WO 2022/204527, the disclosure of which is hereby incorporated herein by reference in its entirety.

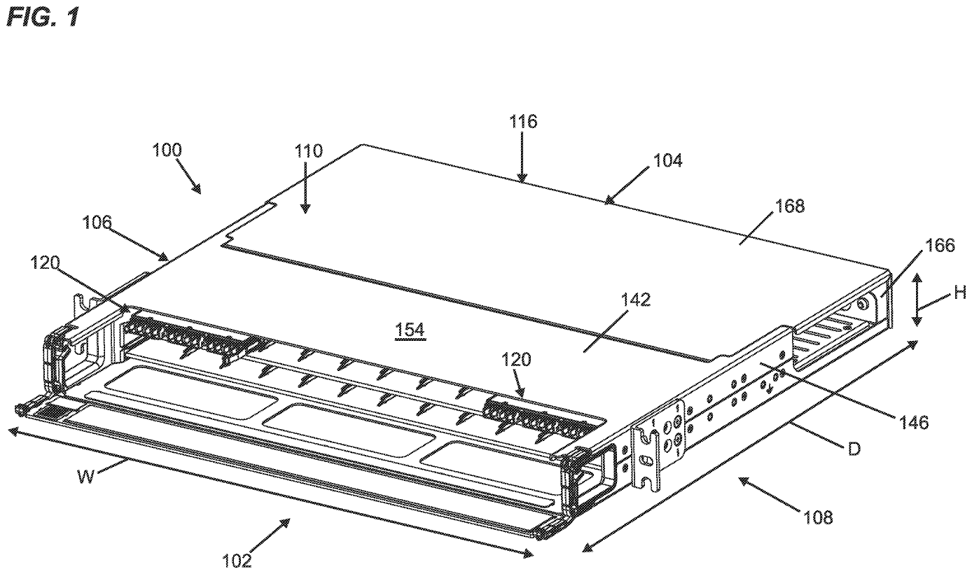

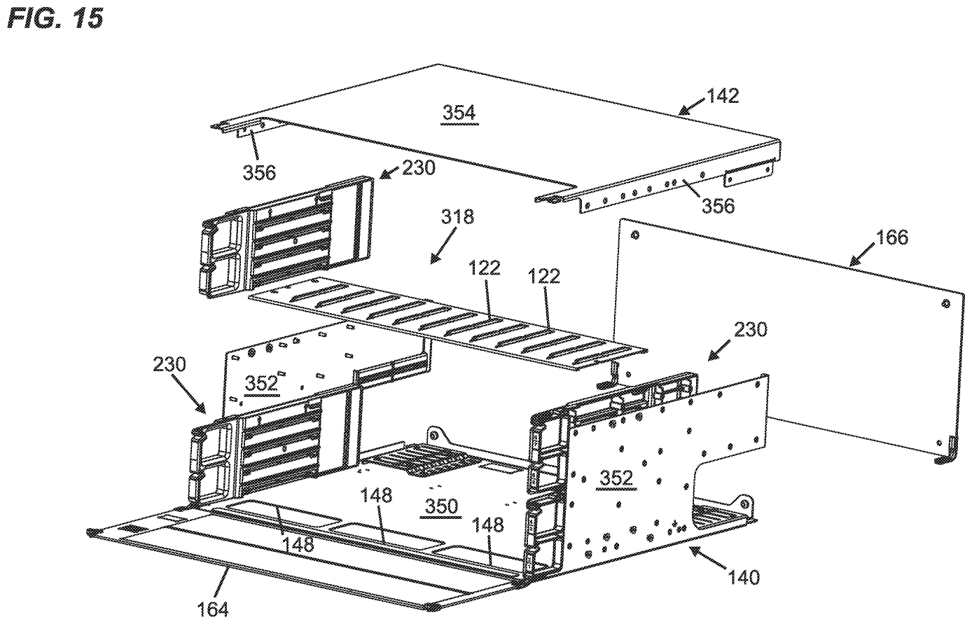

In certain implementations, a rear panel 166 (FIGS. 1 and 15) can be disposed at the rear 104 of the chassis 116, 216, 316, 416. In certain examples, the rear panel 166 is configured to block access to an open rear of the chassis 116, 216, 316, 416. In certain examples, the rear panel 166 selectively blocks access to the cable management region 158. In certain implementations, the rear panel 166 cooperates with a rear cover 168 to selectively block access to the cable management region 158. In certain examples, the rear panel 166 and the rear cover 168 are separate pieces. In certain examples, the rear cover 168 is at least substantially coplanar with the cover 154 of the top piece 142. In certain examples, the rear panel 166 and/or the cover 168 are fastened in place. In other implementations, the communications panel 100, 200, 300, 400 does not include a rear cover 168 so that the cable management region 158 remains exposed.

In certain implementations, each side member 130, 230, 430 of a communications panel 100, 200, 300, 400 includes an indicator section 136, 236, 436 disposed rearward of the tray retention section 132, 232, 432. The indicator section 136, 236, 436 is sized and configured to receive a label L1 at a label region 184. The label L1 may bear indicia identifying the trays of the corresponding tray arrangement 118, 218, 318, 418 (e.g., see FIG. 11). The indicator section 136, 236, 436 may position the label L1 rearward of the tray arrangement 118, 218, 318, 418 (e.g., see FIG. 8).

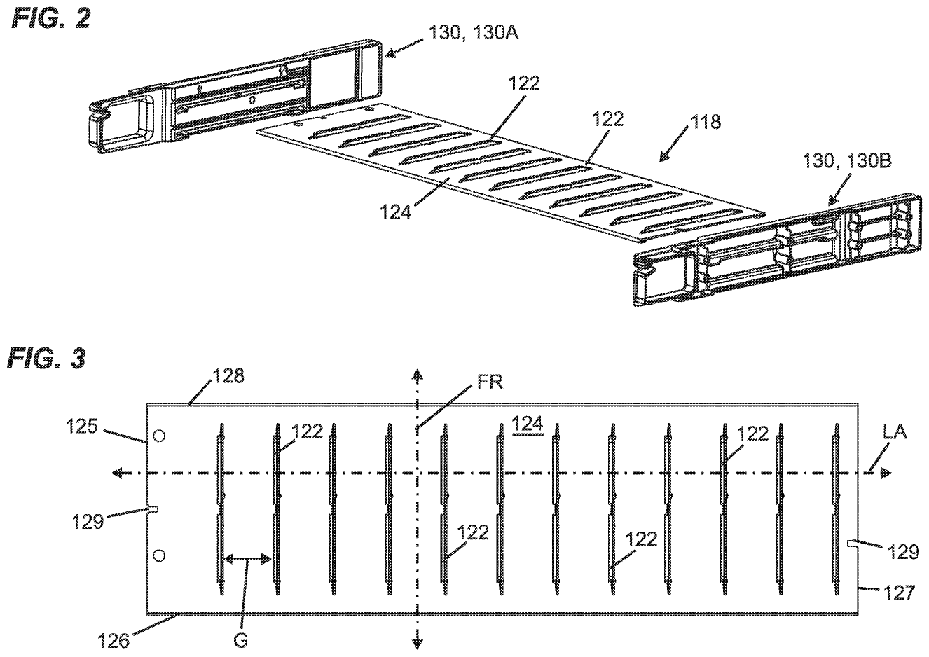

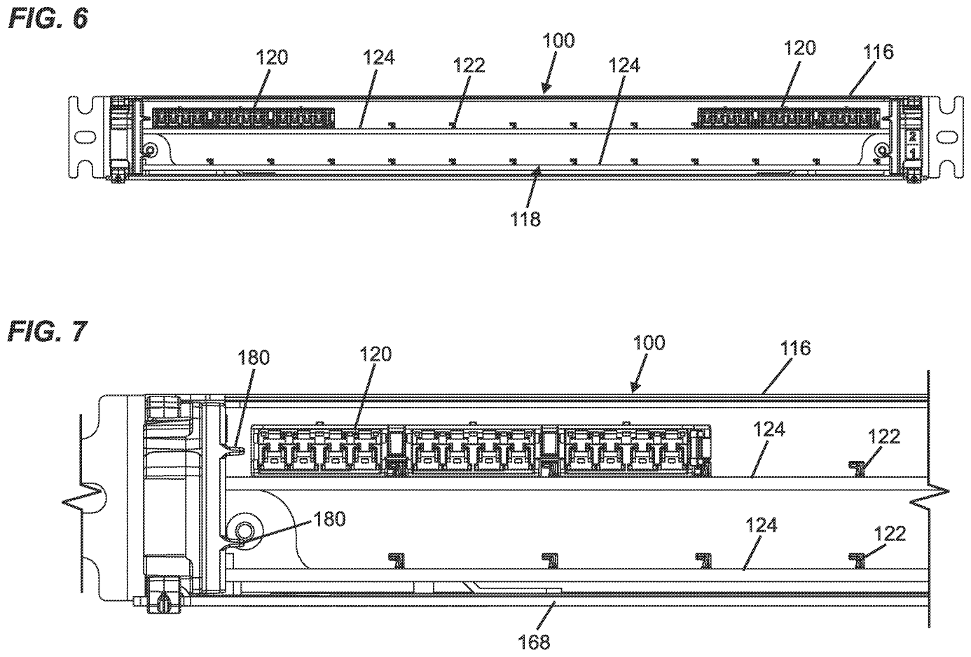

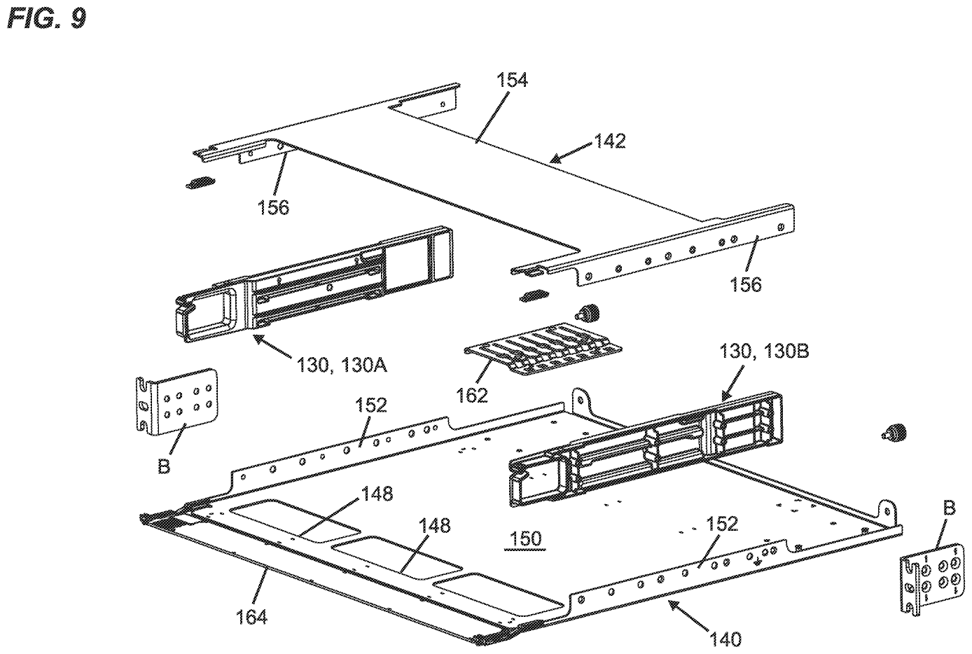

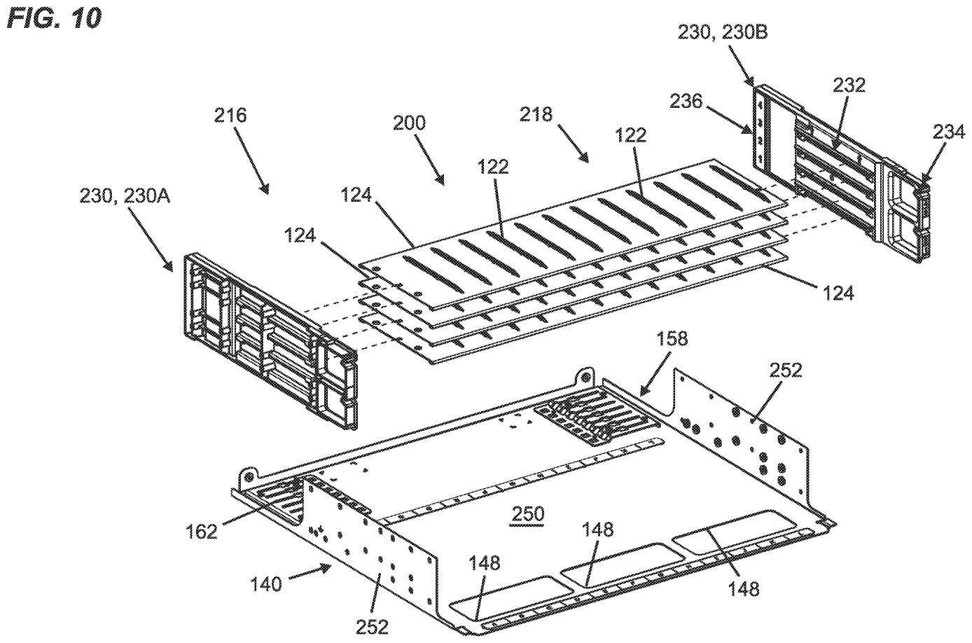

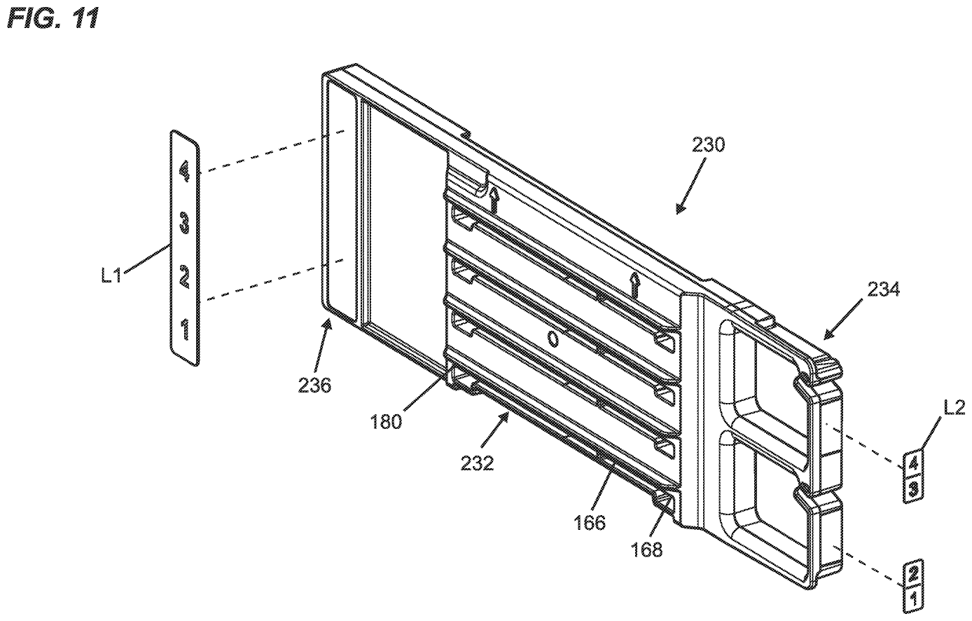

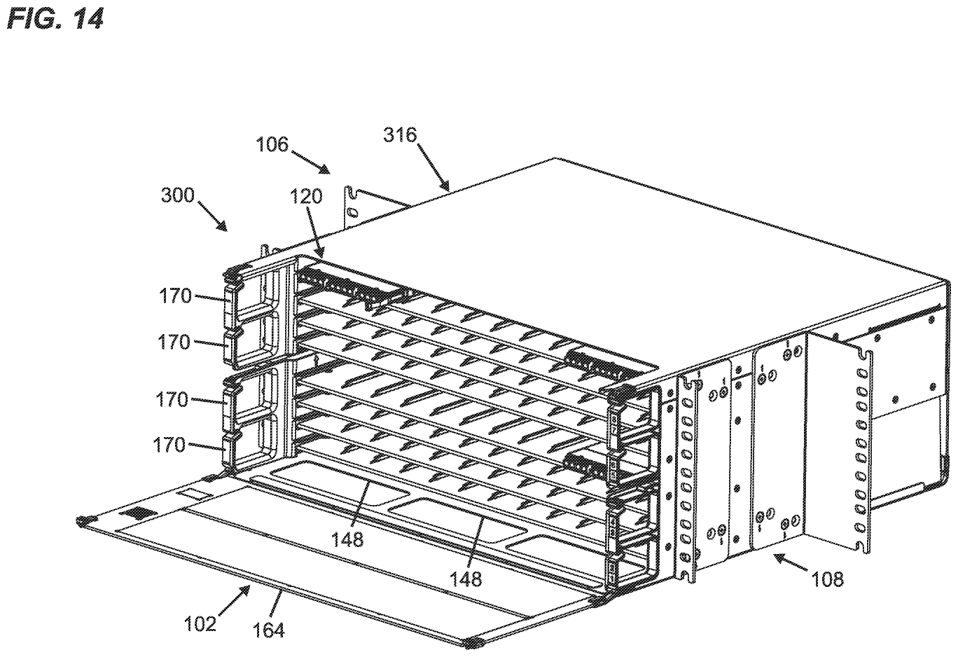

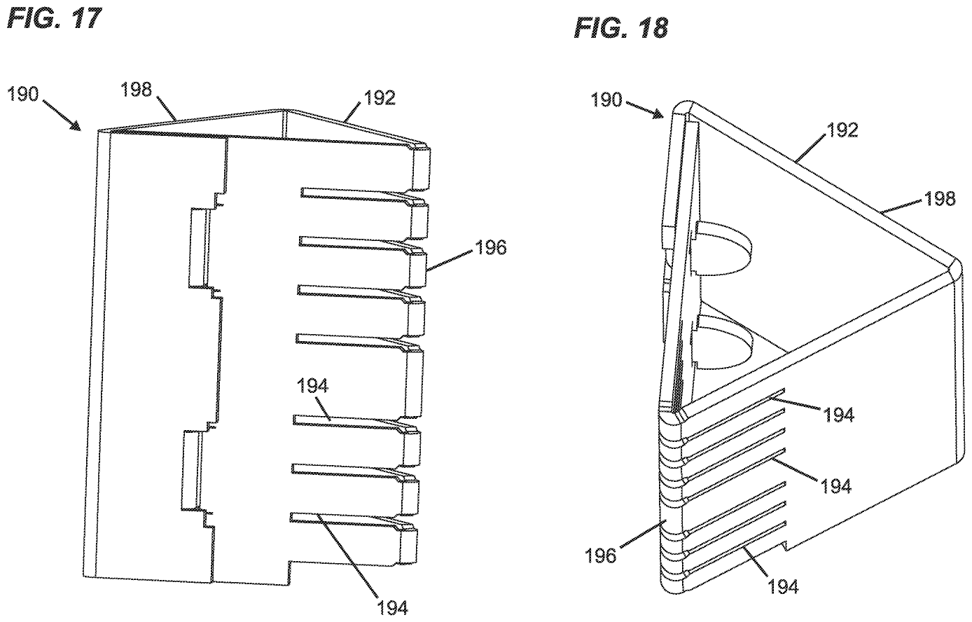

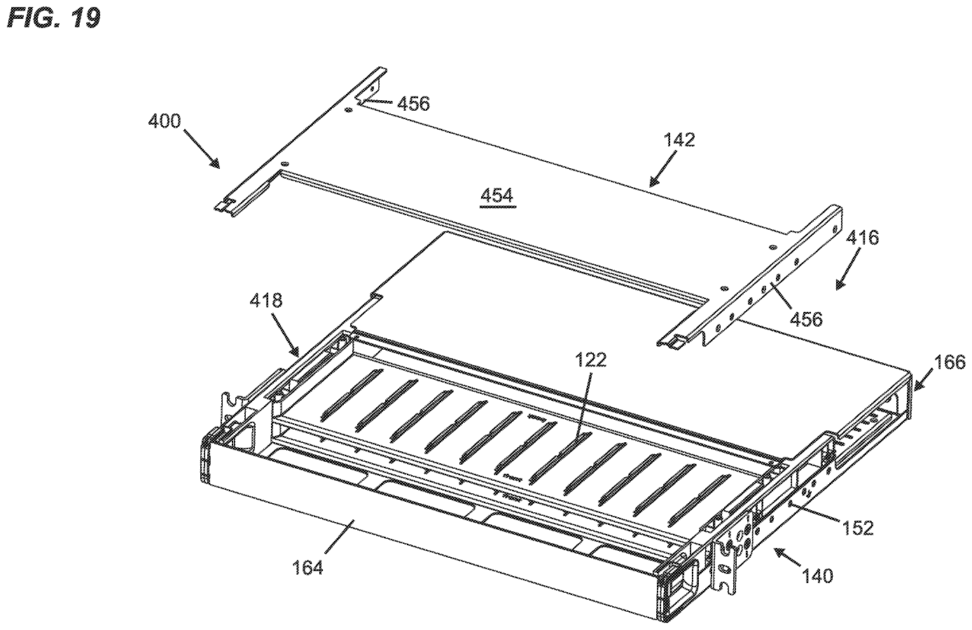

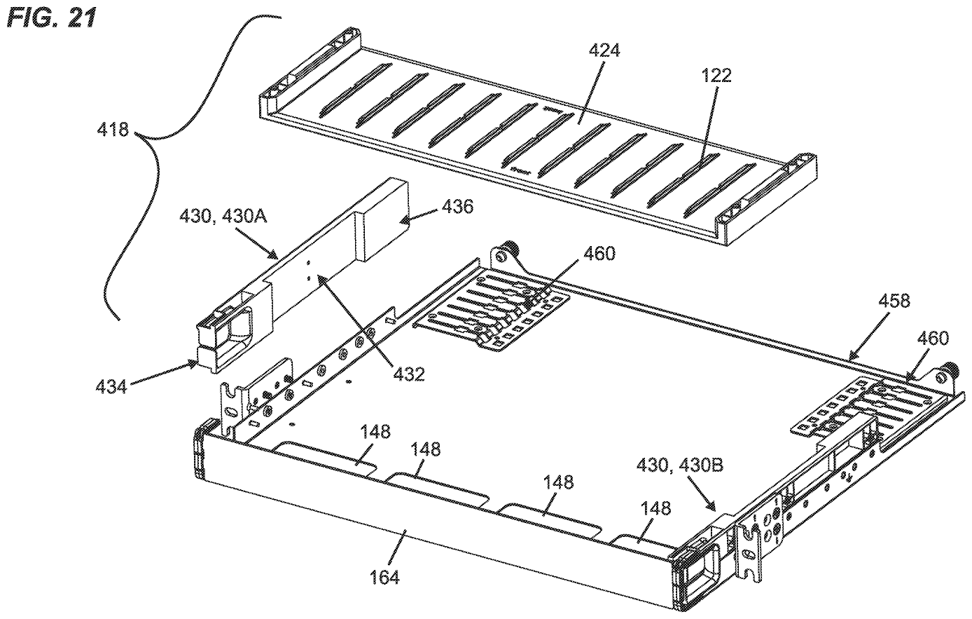

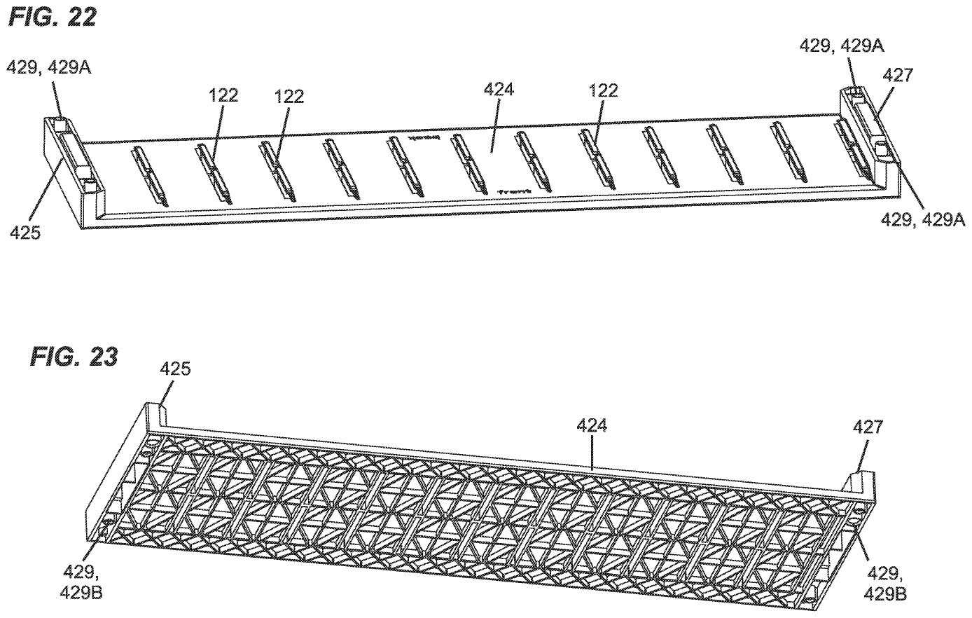

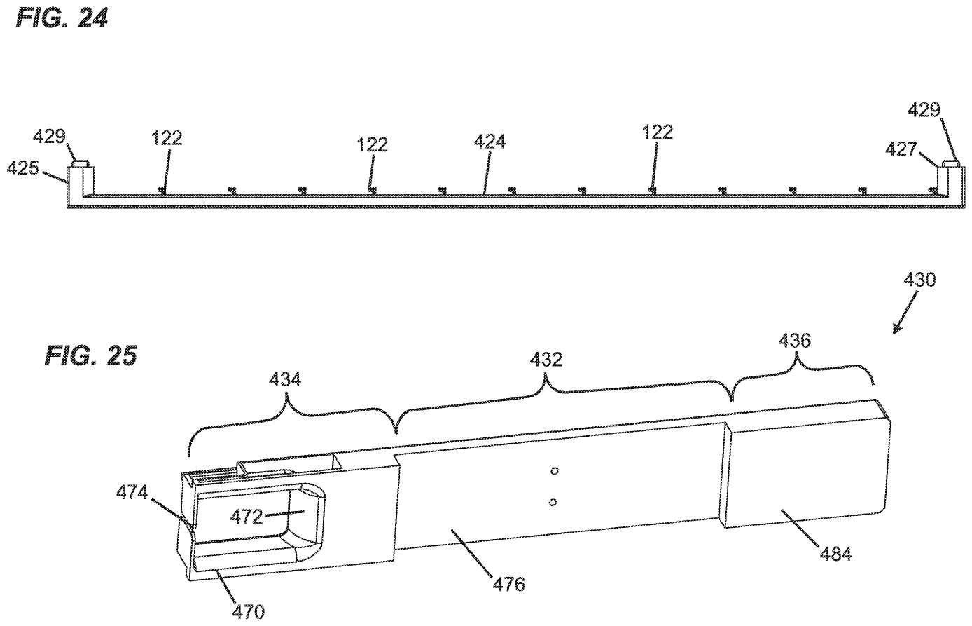

Referring to the figures in general, four example communications panels 100, 200, 300, 400 are shown. FIGS. 1-9 illustrate a first communications panel 100 including a first example tray arrangement 118, which includes a first type of side member 130. FIGS. 10-13 illustrate a second communications panel 200 including a second example tray arrangement 218, which includes a second type of side member 230. FIGS. 14-16 illustrate a third communications panel 300 including a third example tray arrangement 318, which utilizes the second type of side member 230. FIGS. 19-25 illustrate a fourth communications panel 400 including a fourth example tray arrangement 418, which includes a third type of side member 430. FIGS. 17 and 18 illustrate an example packaging stabilizer suitable for use with any of the communications panels 100, 200, 300, 400 disclosed herein.

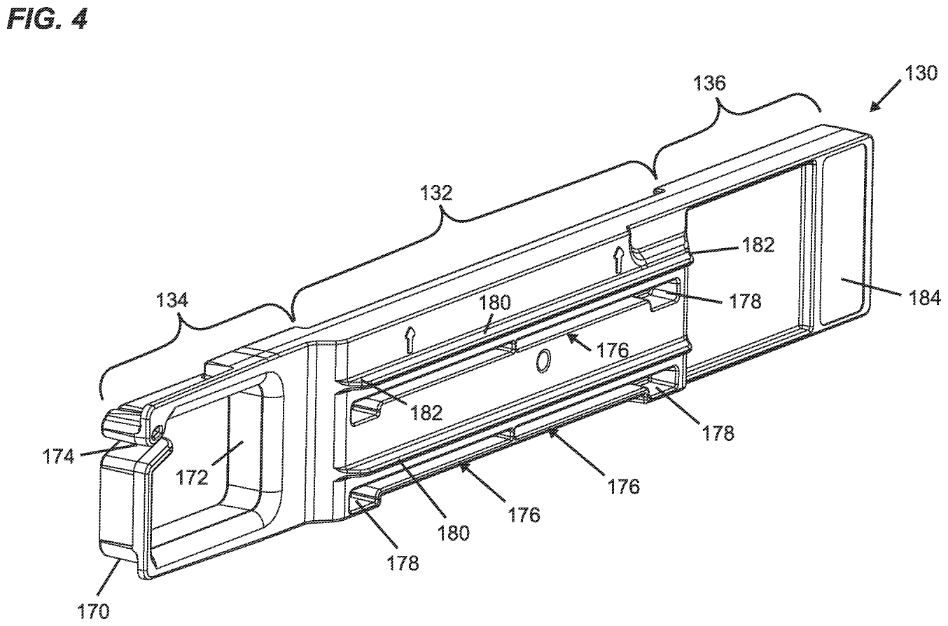

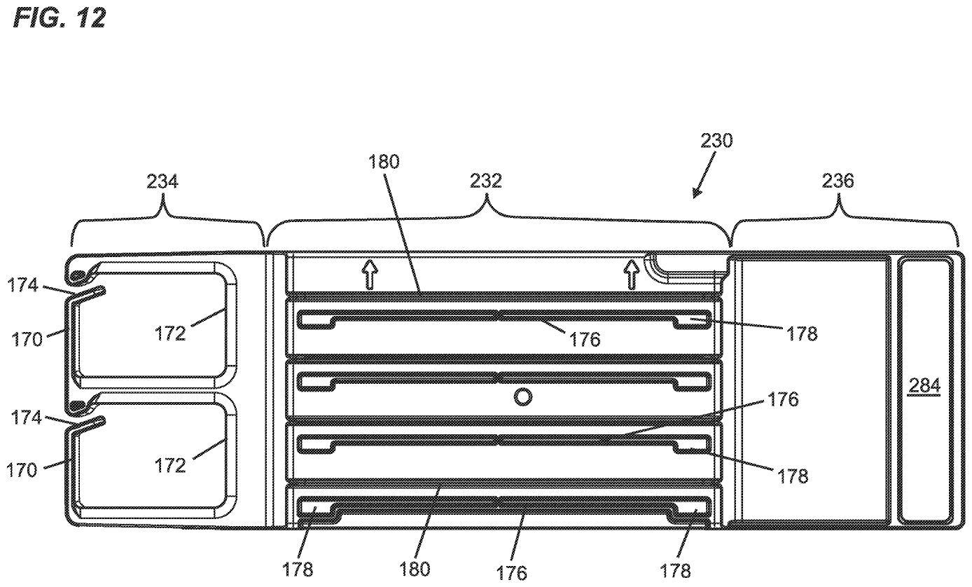

Referring to FIGS. 1-16, the tray retention section 132, 232 defines one or more recesses 176 configured to receive the ends 125, 127 of the tray base 124 (e.g., see FIGS. 4 and 12). In certain examples, the side member 130 holds the ends 125, 127 of the tray bases 124 in a vertically aligned configuration. In certain implementations, the tray retention sections 132 of the example first and second types of side members 130, 230 each define at least one recess 176 for each tray base 124 to be received. In other examples, the tray retention section 132, 232 defines a plurality of recesses 176 to receive each tray base end 125, 127. In the example shown, each tray base end 125, 127 defines a notch 129 so that part of the tray base end 125, 127 fits into one recess 176 and another part of the tray base end 125, 127 fits into an adjacent recess 176 at the tray retention section 132. In certain implementations, the tray base 124 has rolled front and/or rear ends 126, 128. In certain implementations, the recesses 176 define enlarged ends 178 to accommodate the rolled ends 126, 128 of the tray base 124.

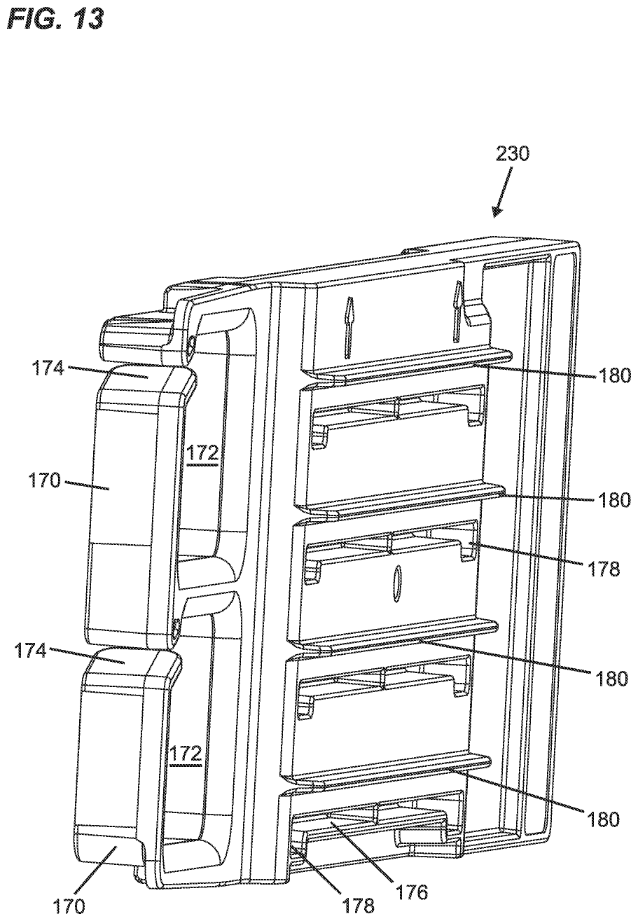

In certain implementations, each side member 130, 230 includes a guide 180 that extends inwardly from the tray retention section 132, 232 (e.g., see FIGS. 4 and 13). The guide 180 has tapered ends 182 at the front and rear. The guide 180 is configured to assist in mounting a cassette 120 to the tray base 124. For example, a side of the cassette 120 can ride along the tapered end 182 and then along a portion of the guide 180 as the cassette 120 is being slidingly mounted to the tray base 124. Accordingly, the guide 180 helps align the cassette 120 with the cassette guides 122 to facilitate mounting the cassette 120 to the tray base 124. In certain examples, the tray retention section 132, 232 includes a corresponding guide 180 for each set of one or more recesses 176 configured to receive the end 125, 127 of a tray base 124. In certain examples, the guides 180 are disposed above the corresponding recesses 176.

In certain implementations, the fiber guide section 134, 234 of each side member 130, 230 includes a retaining ring 170 at the front as discussed above. In the example shown in FIG. 4, the fiber guide section 134 of the side member 130 extends along a majority of the height H of the chassis 116. In the example shown in FIGS. 10-13, the fiber guide section 234 of the side member 230 includes multiple retaining rings 170 cooperating with each other to span the height H of the chassis 216. In certain examples, the retaining rings 170 of the same side member 230 are vertically aligned.

In certain implementations, multiple side members 230 can be disposed at a common side 106, 108 of a chassis 316. For example, two side members 230 can be vertically aligned at the first side 106 of the chassis 316 and another two side members 230 can be vertically aligned at the second side 108 of the chassis 316. In certain implementations, multiple retaining rings 170 are vertically aligned at the front 102 of the chassis 316. In certain implementations, each side member 230 supports the ends 125, 127 of multiple tray bases 124.

Referring to FIGS. 19-25, the tray retention section 432 of each side member 430 defines a single recess 476 extending along the depth D of the chassis 416 and along the height H of the chassis 416. Each of the tray bases 424 includes a first side 425 that fits within the recess 476 of a first side member 430A and a second side 427 that fits within the recess 476 of a second side member 430B. In certain implementations, the first ends 425 of multiple tray bases 424 can fit within the same recess 476 of the first side member 430A and the second ends 427 of multiple tray bases 424 can fit within the same recess 476 of the second side member 430B.

In certain implementations, the tray bases 424 can be positioned in a stacked configuration at the chassis 416 (e.g., see FIG. 19). In certain examples, the tray bases 424 have corresponding alignment members 429 that cooperate to stack the tray bases 424. For example, in certain implementations, the ends 425, 427 of the tray bases 424 define pegs 429A and holes 429B. The pegs 429A of one tray base 424 align with and fit within the holes 429B of another tray base 424 to stack the tray bases 424. The ends of the stacked configuration can fit within the recesses 476 of the side members 470 to axially retain the tray bases 424 relative to the chassis 416.

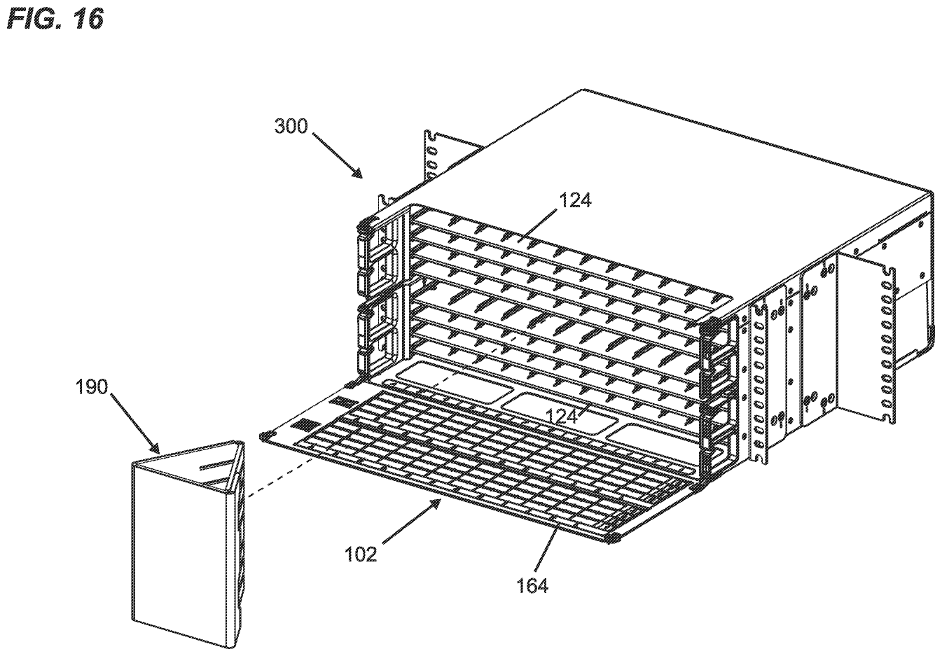

FIGS. 16-18 illustrate an example packaging stabilizer 190 configured to support the tray bases 124, 424 of the communications panel 100, 200, 300, 400 during shipping. The packaging stabilizer 190 includes a body 192 separate from the chassis 116, 216, 316, 416. The body 192 extends along the height H of the chassis 116, 216, 316, 416. The body 192 defines a plurality of slots 194 spaced apart along the height H of the body 192. Each slot 194 corresponds to one of the tray bases 124, 424 of the communications panel 100, 200, 300, 400. Prior to shipping, the door 164 of the chassis 116, 216, 316, 416 is opened and the stabilizer is disposed so that portions of each tray base 124, 424 are slid into corresponding slots 194 in the stabilizer 190. The stabilizer 190 thereby inhibits undue flexing and breaking of the tray bases 124, 424 during shipping.

In certain implementations, the stabilizer body 192 includes a v-shaped section 196 that defines the slots 194. The slots 194 are formed through the vertex of the v-shape 196. In certain examples, the stabilizer body 192 also includes a connecting side 198 spanning the v-shape 196 to provide further reinforcement for the stabilizer body 192. In certain examples, the stabilizer body 190 is formed of a single planar piece that is folded into a triangular shape. In certain examples, one end of the planar piece includes tabs that fit into slits formed at the other end of the planar piece to maintain the stabilizer body 192.

Examples of the disclosure may be described according to the following aspects.

Aspect 1. A communications panel comprising:
a chassis defining an interior, the chassis having a height extending between a bottom and a top, having a width extending between opposite first and second sides, and having a depth extending between a front and a rear;
a first side member mounted to the first side of the chassis, the first side member being elongate along the depth of the chassis, the first side member having a fiber guide section disposed at the front of the chassis and a tray retention section disposed rearwardly of the fiber guide section;
a second side member mounted to the second side of the chassis, the second side member being elongate along the depth of the chassis, the second side member having a fiber guide section disposed at the front of the chassis and a tray retention section disposed rearwardly of the fiber guide section of the second side member; and
a tray elongate along the width of the chassis between opposite first and second ends, the first end being retained at the tray retention section of the first side member, and the second end being retained at the tray retention section of the second side member, the tray defining a plurality of cassettes guides extending along the depth of the chassis, the cassette guides being spaced from each other along the width of the chassis.

Aspect 2. The communications panel of aspect 1, wherein each fiber guide section includes a retaining ring extending along a height of the chassis and along a depth of the chassis, each retaining ring defining an entrance at a front of the retaining ring towards a top of the retaining ring.

Aspect 3. The communications panel of aspect 2, wherein the entrance is angled to extend along both the depth of the chassis and the height of the chassis.

Aspect 4. The communications panel of any of aspects 1-3, wherein the chassis includes a bottom piece and a top piece, the bottom pieces defining the bottom of the chassis, the top piece defining the top of the chassis, and the top and bottom pieces cooperating to define sidewalls of the chassis at the first and second sides; wherein the first side member is mounted to a first of the sidewalls and the second side member is mounted to a second of the sidewalls.

Aspect 5. The communications panel of aspect 4, wherein the bottom piece defines an access aperture at the bottom of the chassis and towards the front of the chassis, each access aperture spanning at least a gap between two adjacent ones of the cassette guides.

Aspect 6. The communications panel of aspect 5, wherein the access aperture is one of a plurality of access apertures disposed in a row to span a majority of the width of the chassis.

Aspect 7. The communications panel of any of aspects 1-6, wherein the tray retention sections define recesses in the first and second side members, the recesses being shaped to receive the respective first and second ends of the tray.

Aspect 8. The communications panel of aspect 7, wherein the tray has rolled ends at a front and a rear of the tray; and wherein the recesses have enlarged portions at a front and a rear of the recesses to accommodate the rolled ends of the tray.

Aspect 9. The communications panel of any of aspects 7-8, wherein the side members include inwardly protruding rails spaced along the height of the chassis from the recesses.

Aspect 10. The communications panel of any of aspects 1-6, wherein the tray retention section of each side member defines a recess configured to slidingly receive a respective end of the tray from a top of the side member.

Aspect 11. The communications panel of aspect 10, wherein the tray is one of a plurality of trays stacked together, and wherein ends of the plurality of trays are received at the recesses in the side members to axially fix the trays along the depth of the chassis.

Aspect 12. The communications panel of aspect 11, further comprising a packaging stabilizer including a v-shaped body separate from the chassis, the body defining a plurality of slots spaced apart from each other in a direction extending along the height of the chassis, each of the slots aligning with and being configured to receive a front portion of a respective one of the trays.

Aspect 13. The communications panel of aspect 12, wherein the packaging stabilizer also includes a connecting piece extending across the v-shaped body to form a triangular cross-sectional profile.

Aspect 14. The communications panel of any of aspects 1-13, wherein each of the first and second side members includes an indicia section disposed rearwardly of the respective tray retention section.

Aspect 15. The communications panel of any of aspects 1-14, wherein the top of the chassis is open above a cable management region defined at the bottom of the chassis, the cable management region including a plurality of cable anchor locations.

Aspect 16. The communications panel of aspect 15, wherein the cable anchor locations are defined by anchor plates mounted to the rear portion.

Aspect 17. The communications panel of aspect 15, wherein the cable anchor locations include cable anchor slot pairs disposed along a row in alternating orientations.

Aspect 18. The communications panel of any of claims 1-17, wherein at least one of the fiber guide sections includes a plurality of retaining rings each extending along a height of the chassis and along a depth of the chassis, each retaining ring defining an entrance at a front of the retaining ring towards a top of the retaining ring.

Aspect 19. The communications panel of any of aspects 1-18, further comprising a support member formed separate from the chassis, the support member including a body defining a plurality of slots each extending along a depth of the body, the slots being spaced from each other along a height of the body to correspond to respective trays mounted within the chassis, wherein each slot is sized to receive a front portion of the respective tray.

Aspect 20. The communications panel of aspect 19, wherein the body has a triangle shaped transverse cross-section.

Aspect 21. The communications panel of aspect 19, wherein the body has a V-shaped transverse cross-section.

Aspect 22. The communications panel of any of aspects 1-21, wherein the first side member is one of a plurality of side members mounted to the first side of the chassis.

Aspect 23. The communications panel of any of aspects 1-22, further comprising a cassette mountable to the tray along the cassette guides, the cassette including at least two rails to engage the cassette guides.

Aspect 24. The communications panel of aspect 23, wherein at least one of the two rails is located at a bottom of the cassette.

Aspect 25. The communications panel of aspect 23 or aspect 24, wherein the cassette carries a plurality of optical adapters.

Aspect 26. The communications panel of any of aspects 1-25, wherein the tray is one of a plurality of trays mounted to the side members at the tray retention sections.

Aspect 27. The communications panel of any of claims 1-26, further comprising a door disposed at the front of the chassis, the door being movable between an open and closed position to selectively cover the front of the chassis.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A communications panel comprising:
a chassis defining an interior, the chassis having a height extending between a bottom and a top, having a width extending between opposite first and second sides, and having a depth extending between a front and a rear;
a first side member mounted to the first side of the chassis, the first side member being elongate along the depth of the chassis, the first side member having a fiber guide section disposed at the front of the chassis and a tray retention section disposed rearwardly of the fiber guide section;
a second side member mounted to the second side of the chassis, the second side member being elongate along the depth of the chassis, the second side member having a fiber guide section disposed at the front of the chassis and a tray retention section disposed rearwardly of the fiber guide section of the second side member; and
a tray elongate along the width of the chassis between opposite first and second ends, the first end being retained at the tray retention section of the first side member, and the second end being retained at the tray retention section of the second side member, the tray defining a plurality of cassettes guides extending along the depth of the chassis, the cassette guides being spaced from each other along the width of the chassis.

2. The communications panel of claim 1, wherein each fiber guide section includes a retaining ring extending along a height of the chassis and along a depth of the chassis, each retaining ring defining an entrance at a front of the retaining ring towards a top of the retaining ring.

3. The communications panel of claim 2, wherein the entrance is angled to extend along both the depth of the chassis and the height of the chassis.

4. The communications panel of claim 1, wherein the chassis includes a bottom piece and a top piece, the bottom pieces defining the bottom of the chassis, the top piece defining the top of the chassis, and the top and bottom pieces cooperating to define sidewalls of the chassis at the first and second sides; wherein the first side member is mounted to a first of the sidewalls and the second side member is mounted to a second of the sidewalls.

5. The communications panel of claim 4, wherein the bottom piece defines an access aperture at the bottom of the chassis and towards the front of the chassis, each access aperture spanning at least a gap between two adjacent ones of the cassette guides.

6. The communications panel of claim 5, wherein the access aperture is one of a plurality of access apertures disposed in a row to span a majority of the width of the chassis.

7. The communications panel of claim 1, wherein the tray retention sections define recesses in the first and second side members, the recesses being shaped to receive the respective first and second ends of the tray.

8. The communications panel of claim 7, wherein the tray has rolled ends at a front and a rear of the tray; and wherein the recesses have enlarged portions at a front and a rear of the recesses to accommodate the rolled ends of the tray.

9. The communications panel of claim 7, wherein the side members include inwardly protruding rails spaced along the height of the chassis from the recesses.

10. The communications panel of any claim 1, wherein the tray retention section of each side member defines a recess configured to slidingly receive a respective end of the tray from a top of the side member.

11. The communications panel of claim 10, wherein the tray is one of a plurality of trays stacked together, and wherein ends of the plurality of trays are received at the recesses in the side members to axially fix the trays along the depth of the chassis.

12. The communications panel of claim 11, further comprising a packaging stabilizer including a v-shaped body separate from the chassis, the body defining a plurality of slots spaced apart from each other in a direction extending along the height of the chassis, each of the slots aligning with and being configured to receive a front portion of a respective one of the trays.

13. The communications panel of claim 12, wherein the packaging stabilizer also includes a connecting piece extending across the v-shaped body to form a triangular cross-sectional profile.

14. The communications panel of claim 1, wherein each of the first and second side members includes an indicia section disposed rearwardly of the respective tray retention section.

15. The communications panel of claim 1, wherein the top of the chassis is open above a cable management region defined at the bottom of the chassis, the cable management region including a plurality of cable anchor locations.

16. The communications panel of claim 15, wherein the cable anchor locations are defined by anchor plates mounted to the rear portion.

17. The communications panel of claim 15, wherein the cable anchor locations include cable anchor slot pairs disposed along a row in alternating orientations.

18. The communications panel of claim 1, wherein at least one of the fiber guide sections includes a plurality of retaining rings each extending along a height of the chassis and along a depth of the chassis, each retaining ring defining an entrance at a front of the retaining ring towards a top of the retaining ring.

19. The communications panel of claim 1, further comprising a support member formed separate from the chassis, the support member including a body defining a plurality of slots each extending along a depth of the body, the slots being spaced from each other along a height of the body to correspond to respective trays mounted within the chassis, wherein each slot is sized to receive a front portion of the respective tray.

20. The communications panel of claim 19, wherein the body has a triangle shaped transverse cross-section.

21. The communications panel of claim 19, wherein the body has a V-shaped transverse cross-section.

22. The communications panel of claim 1, wherein the first side member is one of a plurality of side members mounted to the first side of the chassis.

23. The communications panel of claim 1, further comprising a cassette mountable to the tray along the cassette guides, the cassette including at least two rails to engage the cassette guides.

24. The communications panel of claim 23, wherein at least one of the two rails is located at a bottom of the cassette.

25. The communications panel of claim wherein the cassette carries a plurality of optical adapters.

26. The communications panel of claim 1, wherein the tray is one of a plurality of trays mounted to the side members at the tray retention sections.

27. The communications panel of claim 1, further comprising a door disposed at the front of the chassis, the door being movable between an open and closed position to selectively cover the front of the chassis.
